(19) United States
(12) Patent Application Publication
(10) Pub. No.: US 2010/0038135 A1
(43) Pub. Date: Feb. 18, 2010

(54) SYSTEM AND METHOD FOR EVALUATION OF STRUCTURE-BORN SOUND

(75) Inventors: Olof Hummes, Wadersloh (DE); Sven Krueger, Winsen (DE); Dustin Garvey, Celle (DE)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/540,459

(22) Filed: Aug. 13, 2009

Related U.S. Application Data
(60) Provisional application No. 61/088,815, filed on Aug. 14, 2008.

(51) Int. Cl. E21B 47/00; E21B 49/00; E21B 44/00; G01V 1/40

(52) U.S. Cl. 175/24; 175/50; 367/35

(57) ABSTRACT

A system for evaluation of conditions in a borehole in an earth formation includes: a downhole tool configured to be disposed in the borehole, the downhole tool forming a portion of a drillstring; at least one sensor associated with the downhole tool for recording sound generated in the borehole by the downhole tool and generating data representative of the recorded sound, the recorded sound having a frequency selected from at least one of an audible frequency, a near audible frequency and an ultrasonic frequency; and a processor in operable communication with the at least one sensor, the processor configured to receive the sound data and identify at least one downhole condition selected from at least one of i) a drilling condition, ii) a characteristic of the earth formation and iii) an integrity of the downhole tool, by comparing the recorded sound data to exemplary data patterns.

### CROSS-REFERENCE TO RELATED APPLICATIONS

This application claims the benefit of U.S. Provisional Application Ser. No. 61/088,815, entitled “System and Method for Evaluation of Structure-Born Sound”, filed Aug. 14, 2008, under 35 U.S.C. §119(e), and which is incorporated herein by reference in its entirety.

### BACKGROUND

During drilling and/or FE operations, the integrity of components of the drillstring, such as drill bit assemblies and other downhole tools, is affected by various forces caused by downhole conditions and interaction with an earth formation. Various dynamic measurements are taken to diagnose process conditions, such as drilling dynamics and dysfunctions such as stick slip, whirl and bit bounce. For this purpose, tool movements along specific axes are measured for instance using magnetometers or accelerometers.

Component wear and other conditions, such as contact with a hard formation feature, pose significant threats to the integrity of downhole components. Such conditions can lead to, for example, component failure, flooding and loss of components that delay drilling operations and result in equipment and income loss. Such conditions should be detected as soon as possible so that appropriate action can be taken to prevent damage to the downhole components.

### BRIEF DESCRIPTION OF THE INVENTION

A system for evaluation of conditions in a borehole in an earth formation includes: a downhole tool configured to be disposed in the borehole, the downhole tool forming a portion of a drillstring; at least one sensor associated with the downhole tool for recording sound generated in the borehole by the downhole tool and generating data representative of the recorded sound, the recorded sound having a frequency selected from at least one of an audible frequency, a near audible frequency and an ultrasonic frequency; and a processor in operable communication with the at least one sensor, the processor configured to receive the sound data and identify at least one downhole condition selected from at least one of i) a drilling condition, ii) a characteristic of the earth formation and iii) an integrity of the downhole tool, by comparing the recorded sound data to exemplary data patterns.

A method of evaluating conditions in a borehole in an earth formation includes: disposing a downhole tool in the borehole, the downhole tool forming a portion of a drillstring; recording sound generated in the borehole by at least one sensor associated with the downhole tool, the sound having a frequency selected from at least one of an audible frequency, a near audible frequency and an ultrasonic frequency; generating data representative of the sound; and identifying at least one downhole condition selected from at least one of i) a drilling condition, ii) a characteristic of the earth formation and iii) an integrity of the downhole tool by comparing the recorded sound data to exemplary data patterns.

### BRIEF DESCRIPTION OF THE DRAWINGS

The following descriptions should not be considered limiting in any way. With reference to the accompanying drawings, like elements are numbered alike:

FIG. 1 depicts an embodiment of a well drilling and/or logging system;

FIG. 2 depicts an embodiment of a system for evaluating structure-born sound;

FIG. 3 depicts an embodiment of a system for evaluating structure-born sound; and

FIG. 4 is a flow chart providing an exemplary method for evaluating structure-born sound.

### DETAILED DESCRIPTION OF THE INVENTION

There is provided a system and method for monitoring conditions and/or characteristics of an earth formation and/or a downhole tool or other component of a drillstring. The system and method utilize sound waves generated by interaction between a drill bit and the formation, contact between drillstring components and a side of the borehole and/or sound waves reflected from a drillstring component. In one embodiment, the sound waves have a frequency in the audible, near audible and/or ultrasonic range. In one embodiment, “near audible” refers to a frequency in the range of approximately 1 Hz to 20 Hz. One or more sensors disposed in the downhole tool generate data representative of received sound waves, which is utilized to derive a drilling condition, a characteristic or change in a characteristic of the earth formation and/or an integrity of the downhole tool. A characteristic of the earth formation, such as rock composition and texture, may be referred to as a “lithology” characteristic.

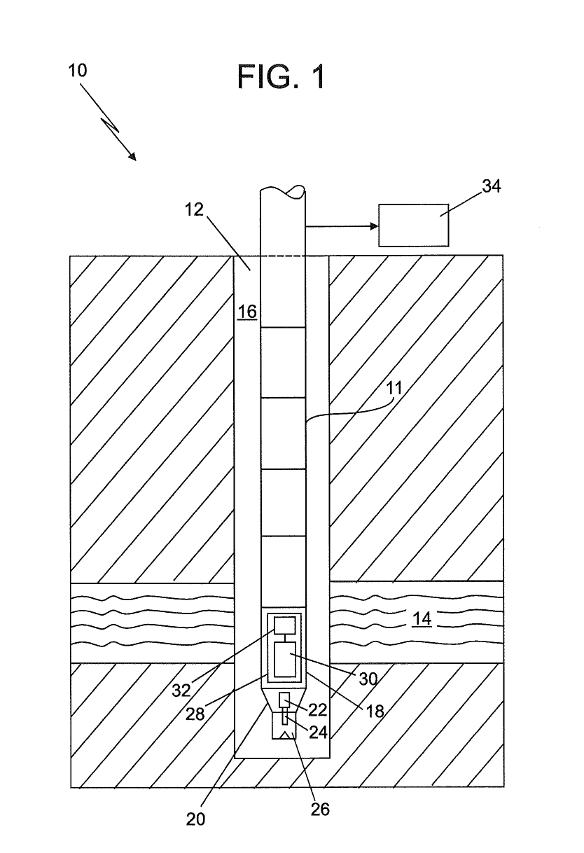

Referring to FIG. 1, an exemplary embodiment of a well drilling and/or logging system 10 includes a drillstring 11 that is shown disposed in a borehole 12 that penetrates at least one earth formation 14 during a drilling operation and makes measurements of properties of the formation 14 and/or the borehole 12 downhole. In one embodiment, such measurements are of sound waves generated in the borehole 12 and/or the drillstring 11 that are used to monitor lithology characteristics and/or conditions of components of the drillstring 11. Drilling fluid, or drilling mud 16 may be pumped through the drillstring 11 and/or the borehole 12. The well drilling system 10 also includes a bottomhole assembly (BHA) 18.

As described herein, “borehole” or “wellbore” refers to a single hole that makes up all or part of a drilled well. As described herein, “formations” refer to the various features and materials that may be encountered in a subsurface environment. Accordingly, it should be considered that while the term “formation” generally refers to geologic formations of interest, that the term “formations,” as used herein, may, in some instances, include any geologic points or volumes of interest (such as a survey area). In addition, it should be noted that “drillstring” as used herein, refers to any structure suitable for lowering a tool through a borehole or connecting a drill to the surface, and is not limited to the structure and configuration described herein.

In one embodiment, the BHA 18 includes a drill bit assembly 20 and associated motors adapted to drill through earth formations. The drill bit assembly 20 is powered by a surface rotary drive, a motor using pressurized fluid (e.g., a mud motor), an electrically driven motor and/or other suitable mechanism.

In one embodiment, the drill bit assembly 20 includes a steering assembly including a steering motor 22 configured to rotationally control a shaft 24 connected to a drill bit 26. The shaft is utilized in geosteering operations to steer the drill bit 26 and the drillstring 11 through the formation 14.

In one embodiment, the BHA 18 is disposed in the well logging system 10 at or near the downhole portion of the drillstring 11. The BHA 18 includes any number of downhole tools 28 for various processes including formation drilling, geosteering, and formation evaluation (FE) for measuring versus depth and/or time one or more physical quantities in or around a borehole.

The downhole tool 28, in one embodiment, includes one or more sensors or receivers 30 to measure frequencies of sound waves generated in the downhole environment. Such sound waves, in one embodiment, are in the audible, near audible and/or ultrasonic frequency range. Examples of a sensor 30 include piezoelectric electromagnetic, electro-dynamic, electrostatic, piezoresistive and magnetostrictive sensors.

In one embodiment, the sound waves are generated by contact between portions of the drillstring 11 and the formation 14, such as during interaction between the drill bit 26 and the formation 14.

In another embodiment, sound waves such as ultrasonic waves are generated by a sound source 32 disposed within the tool 28 and configured to emit sound waves at a selected frequency. Such sources include, for example, magnetostrictive and piezoelectric transducers.

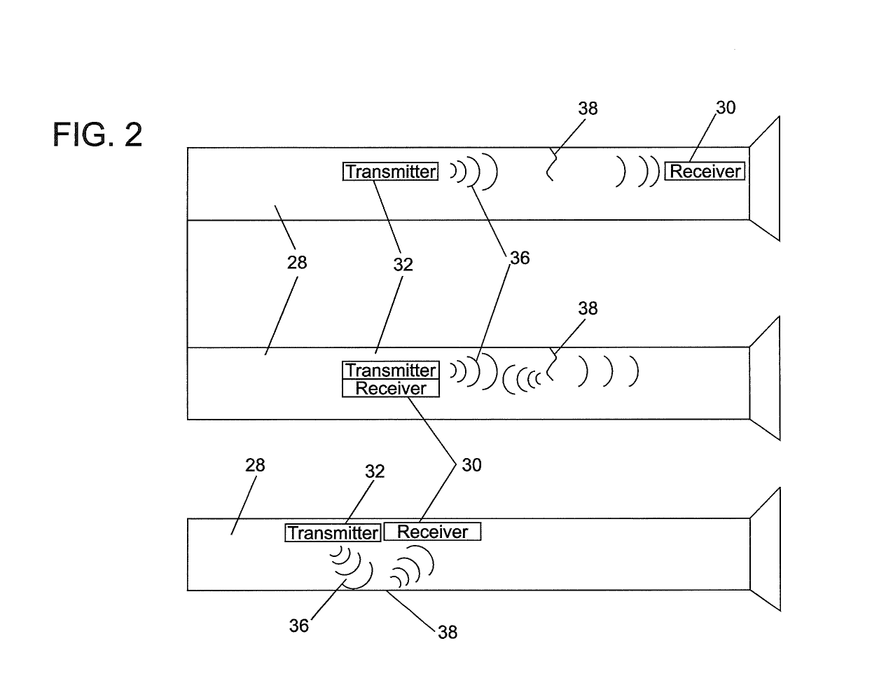

Referring to FIG. 2, examples of configurations of the sound source 32, i.e., transmitter, and the sensor 30, i.e., receiver, located within or on the tool 28 are shown. In each configuration, the sound source 32 emits sound waves 36 that reflect off of a location of the tool 28 which includes a feature or material defect 3 8 such as a crack. The reflected sound waves 36 are received and measured by the sensor 30. Although the embodiments shown herein include a single emitter and receiver, any number of emitters and receivers may be utilized.

Referring again to FIG. 1, the data provided by these sensors 30 is utilized to monitor various downhole conditions. Such downhole conditions include drilling conditions, lithology characteristics and an integrity condition of the downhole tool 28. “Drilling conditions” refers to various drilling parameters of the drillstring, such as drill bit 26 rotational speed, drillstring 11 rotational speed, axial acceleration, tangential acceleration, lateral acceleration, torsional acceleration, bending moments, drill bit whirl, drill bit bouncing, drill bit cutting efficiency, stick-slip conditions. “Lithology characteristics” refers to characteristics of the formation 14. “Integrity” of the downhole tool 28 refers to the operable condition of components of the tool 28, e,.g., the existence of excessive wear or cracks. These downhole conditions are identified via the recorded sound data to allow drilling parameters to be adjusted to avoid damage to the drillstring components.

For example, cracks or wear on the tool 28, indicative in a loss of integrity, cause a shift in the frequency, phase or amplitude of reflected sound waves, which is detectable by the sensor 30. The frequency of sound generated by interactions between the tool 28 or the drill bit 26 and the formation 14 can provide an indication of the formation type currently drilled as well as an indication of drilling efficiency.

Each of the sensors 30 may be a single sensor or multiple sensors located at a single location or at multiple locations. In one embodiment, one or more of the sensors 30 include multiple sensors located proximate to one another and assigned a specific location on the drillstring 11. Furthermore, in other embodiments, each sensor 30 includes additional components, such as clocks, memory processors, etc. In one embodiment, multiple sensors are utilized and connected to a suitable noise subtraction circuit to eliminate or compensate for noise signals.

The downhole tool 28, in one embodiment, includes one or more additional sensors or receivers 30 to measure various additional properties of the formation 14. Such sensors 30 include, for example, nuclear magnetic resonance (NMR) sensors, resistivity sensors, porosity sensors, gamma ray sensors, seismic receivers and others. In other embodiments, the downhole tool 28 includes suitable sensors for measuring drilling conditions such as torque-on-bit, weight-on-bit, rotational speed and low frequency dynamics. Such measurements can be used in conjunction with the sound measurements to provide additional information, such as identifying various phases of the drilling operations, e.g., on and off bottom operation, reaming and steering.

The sound measurements, and optionally additional data generated by additional sensors, are utilized to adjust various loads on selected components of the drillstring 1 1. Such loads include various mechanical loads related to drilling parameters associated with drilling the borehole 12. Examples of such drilling parameters include such as a weight on the drill bit 26, torque on the drill bit 26, drilling fluid 16 flow through the drillstring 11, pressure, drill bit 26 rotational speed, drillstring 11 rotational speed, axial acceleration, tangential acceleration, lateral acceleration, torsional acceleration, and bending moments. Although the sensors 30 described herein are shown as part of the BHA 18, the sensors 30 are disposable at any selected location or locations in the drillstring 11.

In one embodiment, the taking of measurements from the sensors 30 is recorded in relation to the depth and/or position of the downhole tool 28, which is referred to as “logging”, and a record of such measurements is referred to as a “log”. Examples of logging processes that can be performed by the system 10 include measurement-while-drilling (MWD) and logging-while-drilling (LWD) processes, during which measurements of properties of the formations and/or the borehole are taken downhole during or shortly after drilling. The data retrieved during these processes may be transmitted to the surface, and may also be stored with the downhole tool for later retrieval. Other examples include logging measurements after drilling, wireline logging, and drop shot logging.

In one embodiment, the tool 28 is equipped with transmission equipment to communicate ultimately to a surface processing unit 34. Such transmission equipment 34 may take any desired form, and different transmission media and connections may be used. Examples of connections include wired pipe, fiber optic, wireless connections or mud pulse telemetry.

In one embodiment, the surface processing unit 34 and/or the tool 28 include components as necessary to provide for storing and/or processing data collected from the sensor(s) 30. Exemplary components include, without limitation, at least one processor, storage, memory, input devices, output devices and the like. The surface processing unit 34 optionally is configured to control the tool 28.

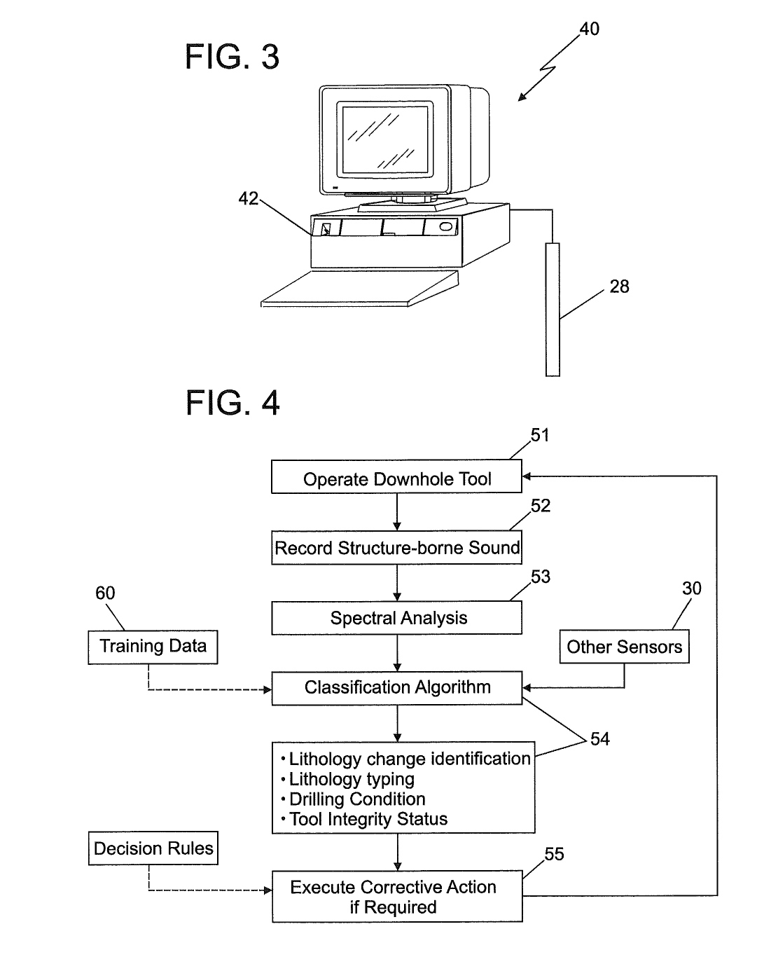

Referring to FIG. 3, there is provided a system 40 for evaluating structure-born sound used in conjunction with the BHA 18 and/or the drillstring 11. The system 40 may be incorporated in a computer or other processing unit capable of receiving data from the tool 28. The processing unit may be included with the tool 28 or included as part of the surface processing unit 34.

In one embodiment, the system 40 includes a computer 42 coupled to the tool 28. Exemplary components include, without limitation, at least one processor, storage, memory, input devices, output devices and the like. As these components are known to those skilled in the art, these are not depicted in any detail herein. The computer 42 may be disposed in at least one of the surface processing unit 34 and the tool 28.

Generally, some of the teachings herein are reduced to an algorithm that is stored on machine-readable media. The algorithm is implemented by the computer 42 and provides operators with desired output.

In one embodiment, the computer 42 includes one or more analysis units that compare received data to previously trained data to identify specific conditions. The analysis units produce spectral patterns of measured sound waves and generate condition identifications based on comparison with exemplary spectral patterns representative of known conditions. In one embodiment, the system 40 is a nonparametric fuzzy inference system (NFIS). The NFIS is a fuzzy inference system (FIS) whose membership function centers and parameters are observations of exemplar inputs and outputs.

FIG. 4 illustrates a method of evaluating structure-born sound using a downhole tool in conjunction with a drillstring. The method includes stages 51-54 described herein. The method may be performed continuously or intermittently as desired. The method is described herein in conjunction with the downhole tool 28, although the method may be performed in conjunction with any number and configuration of sensors and tools, as well as any device for lowering the tool and/or drilling a borehole. The method may be performed by one or more processors or other devices capable of receiving and processing measurement data, such as the computer 42. In one embodiment, the method includes the execution of all of stages in the order described. However, certain stages may be omitted, stages may be added, or the order of the stages changed.

In the first stage 51, the downhole tool 28 is operated to drill the borehole 12. The operation includes various drilling operations such as reaming and geosteering, as well as any desired measurement operating such as LWD operations. In one embodiment, the downhole tool 28 is lowered into the borehole 12 subsequent to a drilling operation.

In the second stage 52, structure-born sound is recorded via the sensors 30. In one embodiment, the structure-born sound is in the audible, near audible and/or ultrasonic range. In one embodiment, the structure-born sound includes one or more of i) sound generated by the interaction between the drill bit 26 and the formation 14 during drilling, ii) sound generated by contact between any drillstring 11 components and a sidewall of the borehole 12 and iii) sound generated by source 32 and reflected from a portion of the drillstring 11.

In the third stage 53, a spectral pattern of the recorded sound is recorded. As referred to herein, a “spectral pattern” refers to a pattern of frequencies over a selected time period. In one embodiment, a relative change of phase and amplitude of emitted and recorded sound is recorded over a selected time period.

In alternative embodiments, the phase, amplitude and/or frequency response to a defined excitation signal are recorded over time. In one embodiment, excitation signal includes sound waves having a defined initial phase, amplitude and frequency, and the response includes the sound waves reflected from a structure.

In one embodiment, prior to utilizing the system 30 for evaluating structure-born sound, the analysis units are trained based on data 60 known to be associated with specific conditions. For example, the system is trained by building a case base in the memory. Such conditions include, in one embodiment, lithology characteristics, drilling conditions and/or tool conditions. Such training includes recording exemplary spectral patterns representative of known conditions.

In one embodiment, the data for each exemplary sound signal is processed to produce exemplary spectral distribution patterns representative of different conditions, such as different lithologies, different levels and types of tool wear, and different drilling conditions.

In one embodiment, each spectral pattern, i.e., both the exemplary spectral patterns and the recorded spectral patterns, is processed by suitable algorithms, regression and classification algorithms or similar to compare raw or processed data to known signatures that are typical for a certain condition. Such processing includes methods such as statistical analysis and data fitting to produce a data curve. Examples of statistical analysis include calculation of a summation, an average, a variance, a standard deviation, t-distribution, a confidence interval, and others. Examples of data fitting include various regression methods, such as linear regression, kernel regression, least squares, segmented regression, hierarchal linear modeling, and others.

In one embodiment, the exemplary spectral patterns and recorded spectral patterns are represented by several functional parameters representing a selected condition. An example of such functions are Gaussian representations of the frequency distribution or other suitable functional distributions. Each of the Gaussians is described by its amplitude, its width, and its mean. In one embodiment, the functional parameters are determined via a regression method such as partial least-squares (PLS), principal component regression (PCR), inverse least-squares (ILS), or ridge regression (RR). The Gaussians can be used to reconstruct the recorded spectral pattern and the corresponding representation in the frequency domain which then can be used to compare the recorded data to functional parameters of exemplary spectral patterns. In another embodiment, the exemplary spectral patterns are processed according to any suitable data reduction method, such as Fourier analysis or wavelet analysis. Other examples include principal components analysis.

In the fourth stage 54, the recorded spectral pattern is classified based on a comparison with known patterns associated with known lithology characteristics, drilling conditions and/or tool conditions. In one embodiment, the analysis units determine which of the exemplary spectral patterns are most similar to each observed query observation.

In one embodiment, “nearest neighbor” (NN) classification is utilized to determine which exemplary spectral pattern is associated with the recorded spectral pattern. NN classification includes assigning to an unclassified sample point the classification of the nearest of a set of previously classified points. An example of nearest neighbor classification is k-nearest neighbor (kNN). kNN refers to the classifier that examines the number “k” of nearest neighbors of a recorded pattern, and NN refers to the classifier that examines the closest neighbor (i.e. k=1). NN classification includes calculating a distance between a recorded spectral pattern and each exemplary spectral pattern, and associating the recorded pattern with a condition that is associated with the exemplary spectral pattern having the smallest distance.

In one embodiment, threshold values for identifying selected conditions are determined. In one example, selected conditions are defined during training, and a number of threshold values are identified as associated with each condition.

In the fifth stage 55, the recorded spectral pattern and/or the associated condition is transmitted to the surface to inform the operator and indicate whether any corrective action is necessary. Manual or automatic adjustment of drilling parameters is performed or other corrective action is taken if needed. It can also be used in a downhole processing unit to allow automatic adjustment of tool parameters, such as steer force or center force, in order to correct for the detected condition. In a further embodiment, corrective action may be automatically initiated based on the identified downhole conditions and predetermined decision rules.

In one embodiment, the method 50 is performed during the drilling operation and yields real time information regarding downhole conditions. As used herein, generation of data in “real-time” is taken to mean generation of data at a rate that is useful or adequate for making decisions during or concurrent with processes such as production, experimentation, verification, and other types of surveys or uses as may be opted for by a user or operator. As a non-limiting example, real-time measurements and calculations may provide users with information necessary to make desired adjustments during the drilling process. In one embodiment, adjustments are enabled on a continuous basis (at the rate of drilling), while in another embodiment, adjustments may require periodic cessation of drilling for assessment of data. Accordingly, it should be recognized that “real-time” is to be taken in context, and does not necessarily indicate the instantaneous determination of data, or make any other suggestions about the temporal frequency of data collection and determination.

The systems and methods described herein provide various advantages over prior art techniques. The system and method described herein, by analyzing the drilling noise and other sound generated during drilling, allows for a very fast way to identify any changes in condition, e.g., providing instantaneous information when a hard formation feature is encountered that could damage the tool or lead to undesired wellpath deviations. The measurement could be used to identify fractures or thin layers, and monitoring of material integrity in critical areas could provide additional safety against flooding or losing components in the borehole.

In support of the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing aspects of the teachings herein. For example, a sample line, sample storage, sample chamber, sample exhaust, pump, piston, power supply (e.g., at least one of a generator, a remote supply and a battery), vacuum supply, pressure supply, refrigeration (i.e., cooling) unit or supply, heating component, motive force (such as a translational force, propulsional force or a rotational force), magnet, electromagnet, sensor, electrode, transmitter, receiver, transceiver, controller, optical unit, electrical unit or electromechanical unit may be included in support of the various aspects discussed herein or in support of other functions beyond this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

1. A system for evaluation of conditions in a borehole in an earth formation, the system comprising:
a downhole tool configured to be disposed in the borehole, the downhole tool forming a portion of a drillstring;
at least one sensor associated with the downhole tool for recording sound generated in the borehole by the downhole tool and generating data representative of the recorded sound, the recorded sound having a frequency selected from at least one of an audible frequency, a near audible frequency and an ultrasonic frequency; and
a processor in operable communication with the at least one sensor, the processor configured to receive the sound data and identify at least one downhole condition selected from at least one of i) a drilling condition, ii) a characteristic of the earth formation and iii) an integrity of the downhole tool, by comparing the recorded sound data to exemplary data patterns.

2. The system of claim 1, wherein the recorded sound is generated by contact between the earth formation and at least one of the drillstring and a drill bit during a drilling operation.

3. The system of claim 1, further comprising a sound source disposed within the downhole tool configured to emit sound waves toward a surface of the downhole tool, the recorded sound data being at least one of sound transmitted across a section of the downhole tool and sound reflected from the surface of the downhole tool.

4. The system of claim 1, wherein the sensor is at least one of a piezoelectric sensor, an electromagnetic sensor, an electro-dynamic sensor, an electrostatic sensor, a piezoresistive sensor and a magnetostrictive sensor.

5. The system of claim 1, wherein generating data includes at least one of: recording a spectral pattern of the sound over a selected time period, and recording a relative change of phase and amplitude between the generated sound and the recorded sound over a selected time period.

6. The system of claim 5, wherein the processor is configured to process the recorded sound via at least one of a statistic analysis and a data fitting process.

7. The system of claim 5, wherein the processor is configured to identify the downhole condition by comparing the sound data to known exemplary spectral patterns representative of the downhole condition.

8. The system of claim 1, wherein the processor is configured to generate the exemplary data patterns by recording exemplary sound waves associated with a known condition and generating an exemplary spectral pattern associated with the known condition.

9. The system of claim 1, wherein the processor is configured to transmit the recorded sound and the downhole condition to a user.

10. The system of claim 1, wherein the processor is configured to adjust a drilling parameter in response to identifying a selected condition.

11. The system of claim 1, wherein disposing the downhole tool includes at least one of drilling the borehole and lowering the downhole tool in the borehole after a drilling operation.

12. A method of evaluating conditions in a borehole in an earth formation, the method comprising:
disposing a downhole tool in the borehole, the downhole tool forming a portion of a drillstring;
recording sound generated in the borehole by at least one sensor associated with the downhole tool, the sound having a frequency selected from at least one of an audible frequency, a near audible frequency and an ultrasonic frequency;
generating data representative of the sound; and
identifying at least one downhole condition selected from at least one of i) a drilling condition, ii) a characteristic of the earth formation and iii) an integrity of the downhole tool by comparing the recorded sound data to exemplary data patterns.

13. The method of claim 12, wherein the sound is generated by contact between the earth formation and at least one of the drillstring and a drill bit during a drilling operation.

14. The method of claim 12, further comprising emitting sound waves from a sound source disposed within the tool, the recorded sound data being at least one of sound transmitted across a section of the downhole tool and sound reflected from a surface of the downhole tool.

15. The method of claim 12, wherein generating data includes at least one of: recording a spectral pattern of the sound over a selected time period, and recording a relative change of phase and amplitude between the generated sound and the recorded sound over a selected time period.

16. The method of claim 15, wherein generating data includes processing the recorded sound via at least one of a statistic analysis and a data fitting process.

17. The method of claim 11, further comprising generating the exemplary data patterns by recording exemplary sound waves associated with a known condition and generating an exemplary spectral pattern associated with the known condition.

18. The method of claim 15, wherein identifying the condition includes processing the recorded spectral pattern into a plurality of functional parameters, and comparing the functional parameters to exemplary functional parameters associated with a known condition.

19. The method of claim 11, further comprising transmitting the recorded sound and the downhole condition to a user.

20. The method of claim 11, further comprising adjusting a drilling parameter in response to identifying a selected condition.
